(19) United States
(12) Patent Application Publication
(10) Pub. No.: US 2025/0208845 A1
(43) Pub. Date: Jun. 26, 2025

(54) INFORMATION PROCESSING DEVICE AND INFORMATION PROCESSING METHOD

(71) Applicants: TOYOTA JIDOSHA KABUSHIKI KAISHA, Toyota-shi (JP); Scalar, Inc., Tokyo (JP)

(72) Inventors: Hiroki MIZAWA, Nagakute-shi (JP); Naoki ISHIHARA, Nisshin-shi (JP); Koji HETSUGI, Toyota-shi (JP); Shumpei SHIMIZU, Shinagawa-ku (JP); Wataru FUKATSU, Shinjuku-ku (JP)

(73) Assignees: TOYOTA JIDOSHA KABUSHIKI KAISHA, Toyota-shi (JP); Scalar, Inc., Tokyo (JP)

(21) Appl. No.: 18/953,708

(22) Filed: Nov. 20, 2024

(30) Foreign Application Priority Data
Dec. 22, 2023 (JP) 2023-216502

(51) Int. Cl. G06F 8/60; G06F 8/72

(52) U.S. Cl. CPC G06F 8/60; G06F 8/72

(57) ABSTRACT

Module information about software modules constituting first software and produced by one or more first companies included in a supply chain of the first software is received from a terminal corresponding to the first companies. Different parts of the module information are stored in a storage device and a distributed ledger that uses a block chain platform. Software information including information about one or more software modules constituting the first software is generated based on one or more pieces of the module information stored in the storage device and the distributed ledger. The software information is transmitted to a terminal corresponding to a second company.

### CROSS-REFERENCE TO RELATED APPLICATION

This application claims priority to Japanese Patent Application No. 2023-216502 filed on Dec. 22, 2023, incorporated herein by reference in its entirety.

### BACKGROUND

### 1. Technical Field

The present disclosure relates to a supply chain of software. In particular, the present disclosure relates to an information processing device and an information processing method.

### 2. Description of Related Art

A system that detects vulnerability of software is known. In this regard, Japanese Unexamined Patent Application Publication No. 2020-021309 (JP 2020-021309 A) discloses a system that manages vulnerability of software using a database that stores configuration information on a software product, for example.

### SUMMARY

The present disclosure can improve reliability in a supply chain of software.

A first aspect of the present disclosure provides an information processing device including a controller configured to: receive module information about a software module from a terminal corresponding to a first entity, the software module being produced by the first entity, one or more of the software modules constituting first software, and one or more of the first entities being included in a supply chain of the first software; store different parts of the module information in a storage device and a distributed record book, the distributed record book using a block chain platform; generate software information including information about the one or more of the software modules constituting the first software, based on one or more pieces of the module information stored in the storage device and the distributed record book; and transmit the software information to a terminal corresponding to a second entity.

A second aspect of the present disclosure provides an information processing device including a controller configured to: receive module information about a software module from a terminal corresponding to a first company, the software module being produced by the first company, one or more of the software modules constituting first software, and one or more of the first companies being included in a supply chain of the first software; store different parts of the module information in a storage device and a distributed ledger, the distributed ledger using a block chain platform; generate software information including information about the one or more of the software modules constituting the first software, based on one or more pieces of the module information stored in the storage device and the distributed ledger; and transmit the software information to a terminal corresponding to a second company.

In the information processing device according to the above aspect, the module information may include first information that represents a dependence relationship between software modules and second information that represents a unique value corresponding to a target software module; and the controller may store the first information in the storage device, and may store the second information in the distributed ledger.

In the information processing device according to the above aspect, the unique value corresponding to the target software module may be a unique value of a body of the target software module or a unique value of a software bill of materials corresponding to the target software module.

In the information processing device according to the above aspect, the controller may generate, as the software information, tree information that indicates a dependence relationship between a plurality of the software modules constituting the first software.

In the information processing device according to the above aspect, the controller may generate, as the software information, tree information that represents a dependence relationship between a plurality of the software modules constituting the first software and unique value information that represents the unique value corresponding to each of the software modules.

In the information processing device according to the above aspect, the controller may be configured to: set, for the second company, a reference authority for the one or more of the software modules constituting the first software; and perform a predetermined process of concealing a software module for which no reference authority is given to the second company, among the one or more of the software modules constituting the first software, when generating the software information.

A third aspect of the present disclosure provides an information processing method executed by one or more first devices respectively corresponding to one or more companies included in a supply chain of first software and a second device that manages information about the first software, which includes: the first devices executing a process including transmitting module information about one or more software modules constituting the first software to the second device, and requesting software information corresponding to the first software from the second device; and the second device executing a process including storing different parts of the received module information in a storage device and a distributed ledger, the distributed ledger using a block chain platform, and acquiring the module information about the one or more software modules constituting the first software from the storage device and the distributed ledger in response to the requesting, and generating the software information corresponding to the first software based on the acquired module information.

In the information processing method according to the above aspect, the module information may include first information that represents a dependence relationship between software modules and second information that represents a unique value corresponding to a target software module; and the second device may store the first information in the storage device, and may store the second information in the distributed ledger.

In the information processing method according to the above aspect, the unique value corresponding to the target software module may be a unique value of a body of the target software module or a unique value of a software bill of materials corresponding to the target software module.

In the information processing method according to the above aspect, the second device may generate, as the software information, tree information that indicates a dependence relationship between a plurality of the software modules constituting the first software.

In the information processing method according to the above aspect, the second device may generate, as the software information, tree information that indicates a dependence relationship between a plurality of the software modules constituting the first software and unique value information that represents the unique value corresponding to each of the software modules.

In the information processing method according to the above aspect, the second device may set a reference authority for the one or more software modules constituting the first software for each of the one or more companies, and may perform a predetermined process of concealing a software module for which no reference authority is given to the company that has requested the software information, among the one or more software modules constituting the first software, when generating the software information.

A fourth aspect of the present disclosure provides a program that causes a computer to execute the above method, and a computer-readable storage medium that stores the program in a non-transitory manner.

With the present disclosure, it is possible to improve reliability in a supply chain of software.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a supply chain according to an embodiment;

FIG. 2 illustrates the relationship among modules supplied by the supply chain;

FIG. 3 illustrates an outline of a process to be performed between company terminals and a server device;

FIG. 4 is a hardware configuration diagram of the server device according to the embodiment;

FIG. 5 is a hardware configuration diagram of the company terminal according to the embodiment;

FIG. 6 is a software configuration diagram of the server device according to the embodiment;

FIG. 7 illustrates an example of module information generated by the company terminal;

FIG. 8 is a software configuration diagram of the company terminal according to the embodiment;

FIG. 9 illustrates an example of a screen in which a software tree is output as an image;

FIG. 10 is a sequence diagram of a process of registering a project in the server device; and

FIG. 11 is a sequence diagram of a process in which the company terminal verifies a module.

### DETAILED DESCRIPTION OF EMBODIMENTS

In recent years, the scale of software to be embedded in devices has become enormous. The software to be embedded in devices may be produced in units of modules by a plurality of companies. For example, a first software module prepared by a company (supplier) located upstream in a supply chain is used by another company located downstream to prepare a second software module. This process is repeatedly performed to prepare a final software product.

Such a system involves an issue in which the relationship among a plurality of software modules becomes unclear when the scale of software increases. For example, a company located downstream in a supply chain may not be able to grasp what software module is used upstream.

When vulnerability or a defect occurs in software, on the other hand, it is required to identify a software module that needs handling and immediately update the software module.

To this end, there is a technique of centrally managing information about a plurality of modules included in software. This technique makes it possible to visualize the relationship among a plurality of software modules using a tree diagram, for example.

Even if information about software modules is centrally managed, however, tampering of a file body due to unauthorized access cannot be detected using the related art. In a supply chain of software, a completed software module is delivered from a certain company to another. Thus, there is no scheme that ensures that the delivered software module is authentic (e.g., has not been tampered with).

Such an issue can be addressed by the information processing device according to the present disclosure.

An aspect of the present disclosure provides an information processing device including a control unit configured to: receive module information about software modules constituting first software and produced by one or more first companies included in a supply chain of the first software, from a terminal corresponding to the first companies; store different parts of the module information in a storage device and a distributed ledger that uses a block chain platform; generate software information including information about one or more software modules constituting the first software, based on one or more pieces of the module information stored in the storage device and the distributed ledger; and transmit the software information to a terminal corresponding to a second company.

The first software is software composed of a plurality of software modules. The first software may be software to be finally provided to consumers. The software modules may be produced by one or more companies constituting a supply chain. Each company is called a downstream company or an upstream company, depending on the position of the company in the supply chain. A downstream company produces a new software module using a software module produced by an upstream company.

The module information is information about the software modules produced by the companies. The module information may include not only basic information on the software modules, but also information about the dependence relationship with other software modules, information about unique values corresponding to the software modules, etc.

For example, a tree diagram of the software modules constituting the first software can be generated by collecting information about the dependence relationship among the software modules.

The unique value corresponding to the software module is typically a unique value (e.g., a hash value) of a software module body (body of the software module). Tampering with the software module can be detected by using such a value.

The unique value corresponding to the software module may not be a unique value of a software module body, as long as the unique value is a value for verifying the authenticity of the software module. For example, the unique value corresponding to the software module may be a unique value of a software bill of materials (hereinafter an “SBOM”) corresponding to the software module. When an SBOM is attached to the software module, tampering with the SBOM itself can be detected by using a unique value of the SBOM.

The module information is stored in a storage device, and a part of the module information is stored in a distributed ledger that uses a block chain platform. This makes it difficult to tamper with the module information. Of the module information, information for verifying the authenticity of the software module such as the unique value corresponding to the software module, in particular, is preferably stored in a distributed ledger that uses a block chain platform.

The control unit generates software information corresponding to the first software based on the acquired module information. The software information may include detailed information on the software modules constituting the first software, information about the dependence relationship among the modules, etc. The software information may include an image that visualizes the dependence relationship among the software modules using a tree structure.

In the following description, a tree diagram that represents the dependence relationship among the software modules will be referred to as a “software tree”.

The software information may include a unique value corresponding to each software module. This allows each company that has acquired the software information to verify that the software module delivered from another company is authentic, for example.

In the following description, the software modules respectively produced by a plurality of suppliers will be referred to simply as “modules”, and the final software product will be referred to as a “final software product”. In one example, the final software product may be supplied to consumers. The supplier companies and the original equipment manufacturing (OEM) companies included in the supply chain will be referred to simply as “companies”. A plurality of hierarchical levels of the supply chain will be referred to as “tiers”.

In the following description, a specific hierarchical level in the supply chain will be expressed by a term “tierN”. N represents a hierarchical level in the supply chain, and means a more downstream level as the number is smaller.

A specific embodiment of the present disclosure will be described below with reference to the drawings. The hardware configuration, the module configuration, the functional configuration, etc. described in relation to the embodiment are not intended to limit the technical scope of the disclosure to only such an embodiment unless specifically stated otherwise.

### First Embodiment

An information processing system according to the present embodiment provides information about a software product supplied by a supply chain including a plurality of companies.

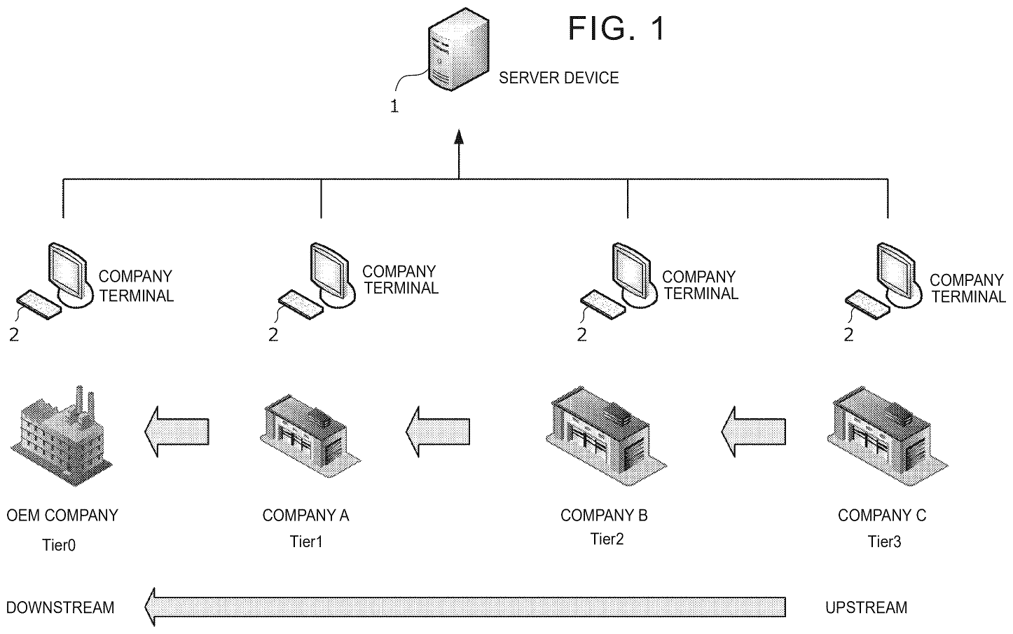

First, the structure of a supply chain will be described. FIG. 1 illustrates an example of a supply chain according to the present embodiment. The supply chain illustrated in FIG. 1 is constituted by an original equipment manufacturing (OEM) company and a plurality of supplier companies. In the example in FIG. 1, a supply chain for manufacturing a software product is assumed, for example. The OEM company manufactures a final software product. The supplier companies (companies A to C) supply a software module produced by the company itself to a company that belongs to an adjacent tier. The supplier companies each produce one or more modules, and deliver the modules to a company located one level downstream. The companies repeat this process, and a final software product is constituted in the final process (i.e., the OEM company).

In the hierarchical levels of the supply chain according to the present embodiment, the side from which a module is delivered is referred to as an “upstream side”, and the side where a new module is produced based on the delivered module is referred to as a “downstream side”. Herein, a company located on the upstream side is referred to as an “upstream company”, and a company located on the downstream side is referred to as a “downstream company”. In addition, a module produced by the upstream company is referred to as an “upstream module”, and a module produced by the downstream company is referred to as a “downstream module”. The downstream module includes the upstream module.

In the present embodiment, the hierarchical levels included in the supply chain are referred to as “tiers”. Tier0 is the lowest level (corresponding to the OEM company) at which the final software product is assembled, and transition is made to the upstream side in the order of Tiers1, 2, and 3. A downstream company may turn into an upstream company, depending on the level of interest. For example, the company B belonging to Tier2 is a downstream company in relation to Tier3, but is an upstream company in relation to Tier1. In this manner, the definitions of “upstream” and “downstream” may vary from level to level. Another company may be present between an upstream company and a downstream company, and another module may be present between an upstream module and a downstream module.

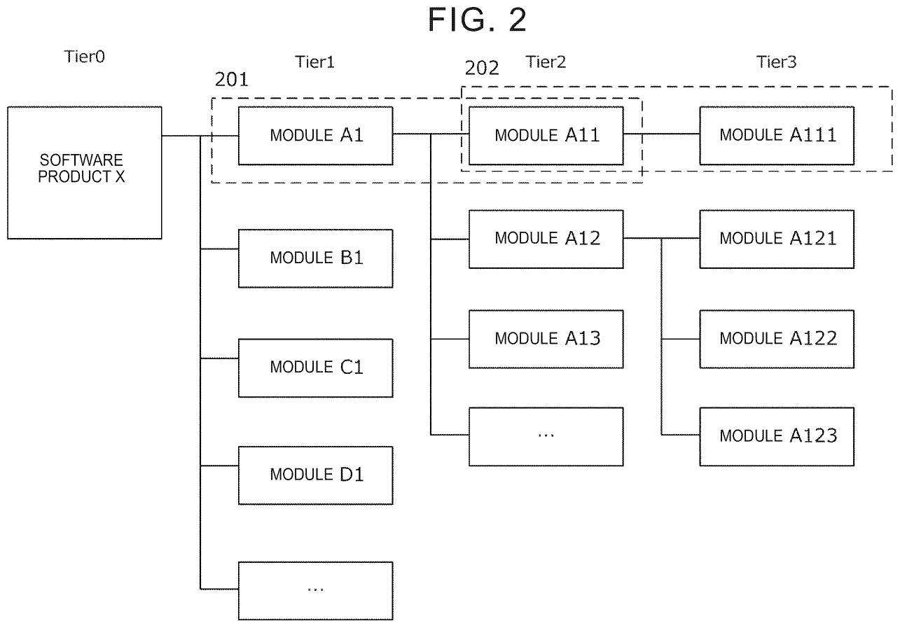

FIG. 2 illustrates the relationship among modules supplied by the supply chain. Here, the supply relationship among modules constituting a final software product X is represented by a tree diagram. In the present example, the final software product X includes modules A1, B1, C1, D1, . . . . The module A1 is configured to include modules A11, A12, A13, . . . . In this manner, the relationship among the modules constituting the final software product can be represented by a tree diagram in which the individual modules serve as nodes.

Hereinafter, a tree diagram for a specific final software product will be referred to as a “software tree”.

The server device 1 according to the present embodiment collects information (hereinafter “module information”) about modules produced by the companies from terminals (company terminals 2) corresponding to the companies, and generates software information based on the collected information. The software information may include a software tree. The module information includes information about the dependence relationship among the modules. The server device 1 can generate a tree diagram using such information.

As illustrated in FIG. 1, the information processing system according to the present embodiment includes a server device 1 and a plurality of company terminals 2. The company terminals 2 respectively correspond to the companies constituting the supply chain. Any number of terminals may correspond to each company.

The server device 1 collects module information from each of the company terminals 2, and generates software information including a software tree based on the collected module information. The software tree may include information about the modules, information (hash value) for verifying the authenticity of the modules, etc. The server device 1 can transmit the generated software information to the company terminals 2.

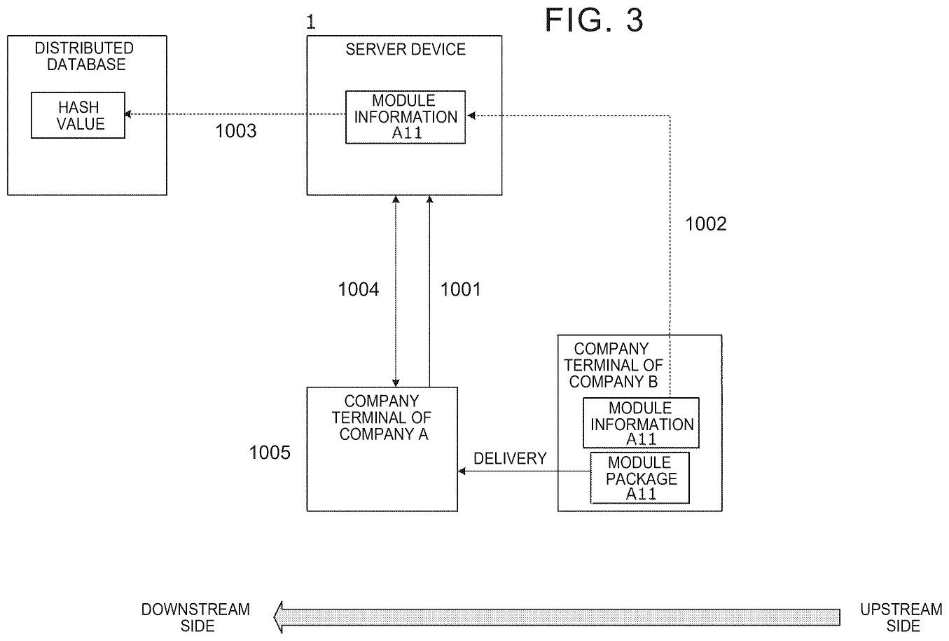

Next, an outline of a process in which the server device 1 generates software information will be described with reference to FIG. 3. FIG. 3 illustrates an outline of a process to be performed between the company terminals 2 and the server device 1. In the example in FIG. 3, it is assumed that a downstream company A and an upstream company B are present between tiers indicated by reference sign 201 in FIG. 2. It is assumed that the company B produces a module A11 and delivers the module A11 to the company A, and that the company A produces a module A1 using the module A11. That is, the module A11 is a child node of the module A1 in the software tree.

First, the company A requests the server device 1 to register a project. The project is a unit for managing module information. The project includes one module to be managed. In the present example, a case where the company A produces a module A1 using a module A11 as illustrated in FIG. 2 is considered. That is, the company A produces a module A1, and the company B produces a module A11.

Information (e.g., a hash value) about the module A11 is required when the company A verifies whether the delivered module A11 is authentic. In this case, the company A registers a range indicated by reference sign 201 as a project. The project manages the module A11. The company that registers a project invites other companies related to the project to the system. In the present example, the company A invites the company B that produces the module A11 to the system. As illustrated in FIG. 3, the company A registers a project in the server device 1, and invites the company B (1001).

The company B participating in the project transmits information (module information) about a module produced by the company itself to the server device 1 (1002). In the present example, the company terminal corresponding to the company B transmits module information (referred to as “module information A11”) about the module A11 to the server device 1. The module information makes a one-to-one correspondence with the project.

The module information includes not only basic information on the module, but also information (hereinafter “unique value information”) for verifying the authenticity of the module. When the module is provided in the form of a single file (package), the unique value information may be a hash value of the package (hereinafter referred to as a “module package”). Alternatively, the unique value information may be a hash value of a Software Bill of Materials (SBOM) corresponding to the module A11.

The module information further includes information (hereinafter “dependence relationship information”) that indicates the dependence relationship among modules. For example, when the module A11 is constituted using a module A111 located further upstream, the module information on the module A11 may include dependence relationship information indicating that “this module depends on the module A111”. The dependence relationship information may be represented by a relationship among modules, or may be represented by a relationship among projects. For example, the module information on the module A11 may include dependence relationship information indicating that “this project depends on a project 202”.

The module information transmitted from the company terminal 2 is stored in the server device 1.

When the collection of the module information corresponding to the project is completed, the server device 1 registers unique value information (a hash value in the present embodiment) included in the module information in a distributed ledger (distributed database). For example, as illustrated in FIG. 3, the server device 1 registers a hash value of the module in the distributed database (1003). The distributed database is a database that uses a block chain platform. The distributed database may be constituted by a plurality of computers including a plurality of company terminals 2. In the present embodiment, of a plurality of pieces of information included in the module information, those other than the unique value information are stored in the server device 1, and only the unique value information is stored in the distributed database.

The server device 1 can generate information (software information) about the final software product based on the module information collected in units of projects. The software information may include basic information on the modules included in the final software product, and a tree (software tree) that represents the dependence relationship among the modules, for example. The server device 1 may generate a graphical user interface (GUI) that visualizes the software tree, for example, in response to a request from the company terminal 2, and provide the GUI to the company terminal 2. For example, as illustrated in FIG. 3, software information including a hash value of the module A11 is acquired from the server device (1004).

In addition, the server device 1 can provide unique value information on the modules to the company terminal 2 as the software information. The unique value information on the modules is acquired from the distributed database. For example, when an operator of the company terminal 2 selects a specific module on the software tree, a corresponding unique value (hash value) may be outputted. This allows the companies that constitute the supply chain to verify a correct hash value for the software module (module A11) delivered from an upstream company. For example, as illustrated in FIG. 3, the authenticity of the module is verified using a hash value (1005). The authenticity of the module can be verified based on the hash value.

### Hardware Configuration

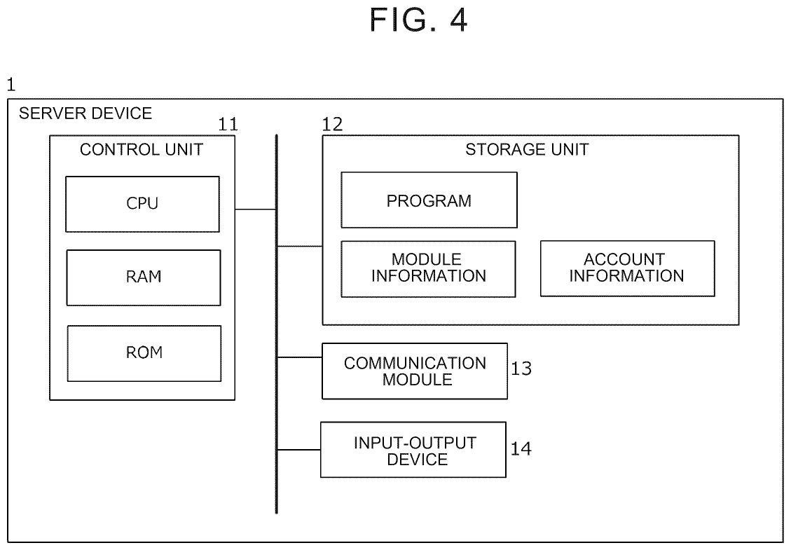

Next, the hardware configuration of the devices constituting the system will be described. FIG. 4 schematically illustrates an example of the hardware configuration of the server device 1 according to the present embodiment. The server device 1 is a computer that includes a control unit (controller) 11, a storage unit 12, a communication module 13, and an input-output device 14.

The server device 1 may be a computer that includes a processor (e.g., a central processing unit (CPU) or a graphics processing unit (GPU)), a main storage device (e.g., a random access memory (RAM) or a read only memory (ROM)), and an auxiliary storage device (e.g., an erasable programmable read only memory (EPROM), a hard disk drive, or a removable medium). An operating system (OS), various programs, various tables, etc. are stored in the auxiliary storage device. The programs stored in the auxiliary storage device are executed such that various functions (software modules) can be implemented to meet a predetermined purpose as described later. Some or all of the functions may be implemented as hardware modules by a hardware circuit such as an application specific integrated circuit (ASIC) or a field programmable gate array (FPGA), for example.

The control unit 11 is an arithmetic unit that implements various functions of the server device 1 by executing a predetermined program. The control unit 11 can be implemented by a hardware processor such as a CPU, for example. The control unit 11 may be configured to include a RAM, a ROM, a cache memory, etc.

The storage unit 12 is a unit that stores information, and is constituted by a storage medium such as a RAM, a magnetic disk, or a flash memory. The storage unit 12 stores programs to be executed by the control unit 11, data to be used by the programs, etc. A database is built in the storage unit 12. The database stores pieces of module information collected from the company terminals 2 and pieces of account information for logging in from the company terminals 2. Details will be described later.

The communication module 13 is a communication interface for connecting the server device 1 to a network. The communication module 13 may be configured to include a network interface board and a wireless communication interface for wireless communication, for example. The server device 1 can perform data communication with other computers (e.g., the company terminals 2) via the communication module 13.

The input-output device 14 is a unit that receives an input operation performed by an operator and presents information to the operator. Specifically, the input-output device 14 includes input devices such as a mouse and a keyboard, and output devices such as a display and a speaker. The input-output device may be an integrated device such as a touch panel display, for example.

In the specific hardware configuration of the server device 1, any component may be omitted, replaced, or added as appropriate depending on embodiments. For example, the control unit 11 may include a plurality of hardware processors. The hardware processor may be a microprocessor, an FPGA, a GPU, etc. The input-output device 14 may be omitted, or an input-output device other than those indicated as examples (e.g., an optical drive) may be added. The server device 1 may be constituted by a plurality of computers. In this case, the hardware configurations of the computers may or may not agree with each other.

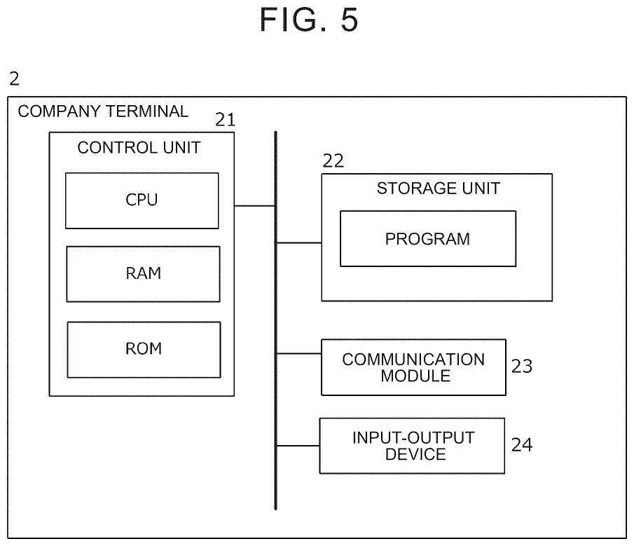

FIG. 5 schematically illustrates an example of the hardware configuration of the company terminal 2 according to the present embodiment. The company terminal 2 is a computer that includes a control unit 21, a storage unit 22, a communication module 23, and an input-output device 24.

Similarly to the server device 1, the company terminal 2 may be a computer that includes a processor (e.g., a CPU or a GPU), a main storage device (e.g., a RAM or a ROM), and an auxiliary storage device (e.g., an EPROM, a hard disk drive, or a removable medium). Some or all of the functions (software modules) may be implemented as hardware modules by a hardware circuit such as an ASIC or an FPGA, for example.

The control unit 21 is an arithmetic unit that implements various functions (software modules) of the company terminal 2 by executing a predetermined program. The control unit 11 can be implemented by a hardware processor such as a CPU, for example. The control unit 21 may be configured to include a RAM, a ROM, a cache memory, etc.

The storage unit 22 is a unit that stores information, and is constituted by a storage medium such as a RAM, a magnetic disk, or a flash memory. The storage unit 22 stores programs to be executed by the control unit 21, data to be used by the programs, etc.

The communication module 23 is a communication interface for connecting the company terminal 2 to a network. The communication module 23 may be configured to include a network interface board and a wireless communication interface for wireless communication, for example. The company terminal 2 can perform data communication with other computers (e.g., the server device 1 and the other company terminals 2) via the communication module 23.

The input-output device 24 is a unit that receives an input operation performed by an operator and presents information to the operator. Specifically, the input-output device 24 includes input devices such as a mouse and a keyboard, and output devices such as a display and a speaker. The input-output device may be an integrated device such as a touch panel display, for example.

In the specific hardware configuration of the company terminal 2, any component may be omitted, replaced, or added as appropriate depending on embodiments, similarly to the server device 1.

### Software Configuration

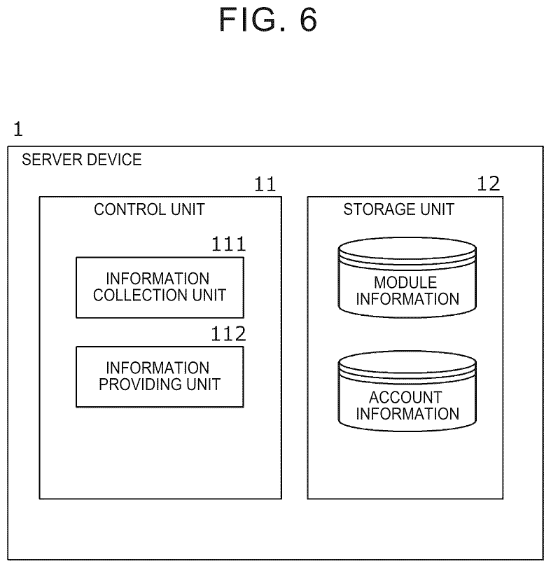

Next, the software configuration of the devices constituting the system will be described. FIG. 6 schematically illustrates the software configuration of the server device 1 according to the present embodiment. In the present embodiment, the control unit 11 is configured to include two software modules that are an information collection unit 111 and an information providing unit 112. The software modules may be implemented by the control unit 11 (CPU) executing the programs stored in the storage unit 12. Information processing to be executed by the information collection unit 111 and the information providing unit 112 is synonymous with information processing to be executed by the control unit 11.

The information collection unit 111 is configured to execute a process of collecting module information from the company terminals 2 and storing the module information in the storage unit 12.

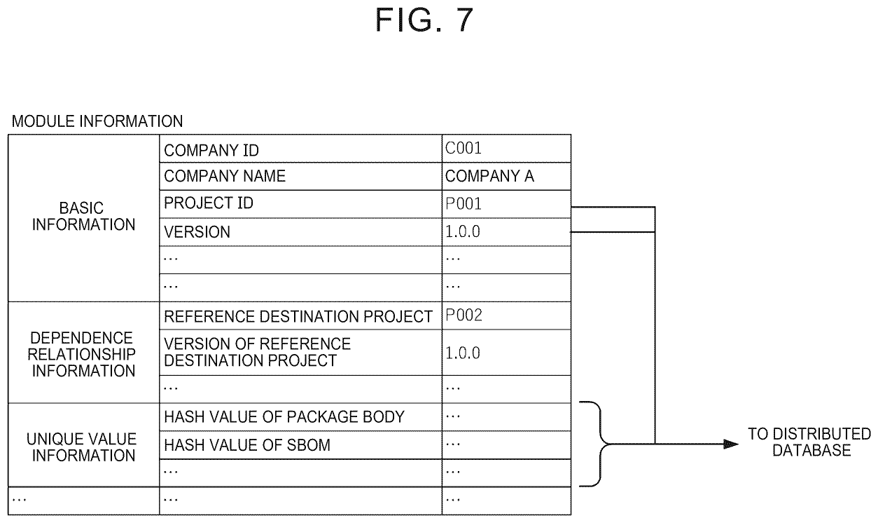

FIG. 7 illustrates an example of the module information collected by the information collection unit 111. One piece of module information corresponds to one project. The module information may be input via an operator of the company terminal 2. In the present embodiment, the module information is configured to include three kinds of information, namely basic information, dependence relationship information, and unique value information.

The basic information is configured to include information about the module such as the identifier of a company that produces the target module, the company name, the identifier of the project (the identifier of the module), and the version.

The dependence relationship information includes information about another project (“reference destination project” in the example in FIG. 7) on which the target project depends and the version. For example, when a module A is created with reference to a module B, it can be said that a project corresponding to the module A depends on a project corresponding to the module B.

The dependence relationship information may include the identifier of another module reference by the target module and the relationship of connection among the modules (e.g., the relationship of connection among nodes in a tree structure).

The unique value information includes information for verifying the authenticity of the target module.

When the target module is exchanged between companies in the form of a single file (hereinafter a “module package”), the unique value information may be a hash value of the file. When the target module is exchanged between companies together with an SBOM, the unique value information may be a hash value etc. of the SBOM attached to the target module.

The information collection unit 111 provides an interface that allows an operator of the company terminal 2 to input module information, and acquires such information. The information collection unit 111 may receive information indicating that input of module information has been completed from the company terminal 2.

The module information collected by the server device 1 is stored in the database built in the storage unit 12.

In addition, the information collection unit 111 copies the unique value information included in the module information to the distributed database at the timing when the collection of the module information included in the target project is completed.
By executing this process for a plurality of projects, the unique value information submitted by each company can be stored in the distributed database that uses a block chain platform, that is, a database that is difficult to tamper with.

The information providing unit 112 generates software information about the final software product based on the module information stored in the storage unit 12 and the distributed database, and provides the software information to the company terminal 2. In the present embodiment, when an operator of the company terminal 2 requests the server device 1 to provide software information, the information providing unit 112 performs processing to provide information to the company terminal 2.

The server device 1 generates software information that includes information that represents the dependence relationship among a plurality of modules included in the final software product, detailed information (basic information and unique value information) on the modules, etc., for example. The software information is converted into an image etc. by the company terminal 2 to be output.

The storage unit 12 stores the module information transmitted from the company terminal 2 and the account information. In the present embodiment, an operator of each company logs into the server device 1 via the company terminal 2 using an account of the corresponding company to perform interaction between the server device 1 and the company terminal 2. The account information is information about an account corresponding to each company constituting the supply chain. The method of accessing the server device 1 is not limited to such an example, and may be selected as appropriate depending on embodiments.

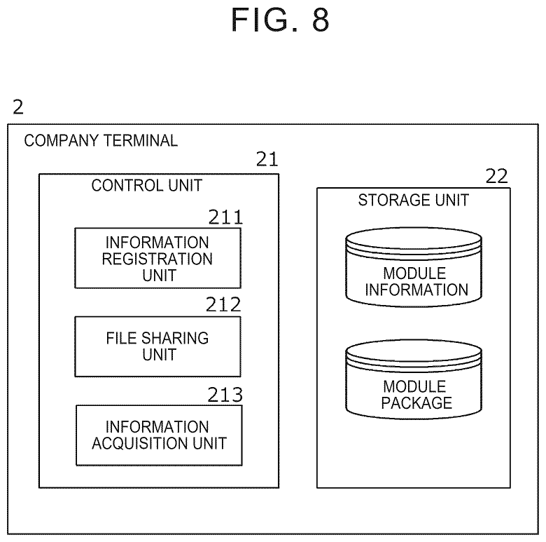

FIG. 8 schematically illustrates the software configuration of the company terminal 2 according to the present embodiment. In the present embodiment, the control unit 21 is configured to include three software modules that are an information registration unit 211, a file sharing unit 212, and an information acquisition unit 213. The software modules may be implemented by the control unit 21 (CPU) executing the programs stored in the storage unit 22. Information processing to be executed by the information registration unit 211, the file sharing unit 212, and the information acquisition unit 213 is synonymous with information processing to be executed by the control unit 21.

The information registration unit 211 is configured to generate information (module information) about a software module corresponding to the company terminal 2. The module information may be input via a device operator. As described above with reference to FIG. 7, the module information is configured to include basic information, dependence relationship information, and unique value information.

The information registration unit 211 is configured to acquire such information via an operator of the company terminal 2 and transmit the information to the server device 1 at any timing.

The file sharing unit 212 is configured to share files between companies. In the present embodiment, the company terminals 2 have a file sharing function that allows companies with business relationships to transmit and receive files to and from each other. For example, the company terminal 2 corresponding to an upstream company shares a module package to be delivered to a downstream company, and the company terminal 2 corresponding to the downstream company acquires the module package. The subject of sharing may be a module package (i.e., a module body), or may be an SBOM corresponding to the relevant module.

The information acquisition unit 213 is configured to request the server device 1 to provide software information and output the software information transmitted from the server device 1. For example, the information acquisition unit 213 may generate a GUI (software tree) that visualizes the dependence relationship among modules based on the software information transmitted from the server device 1.

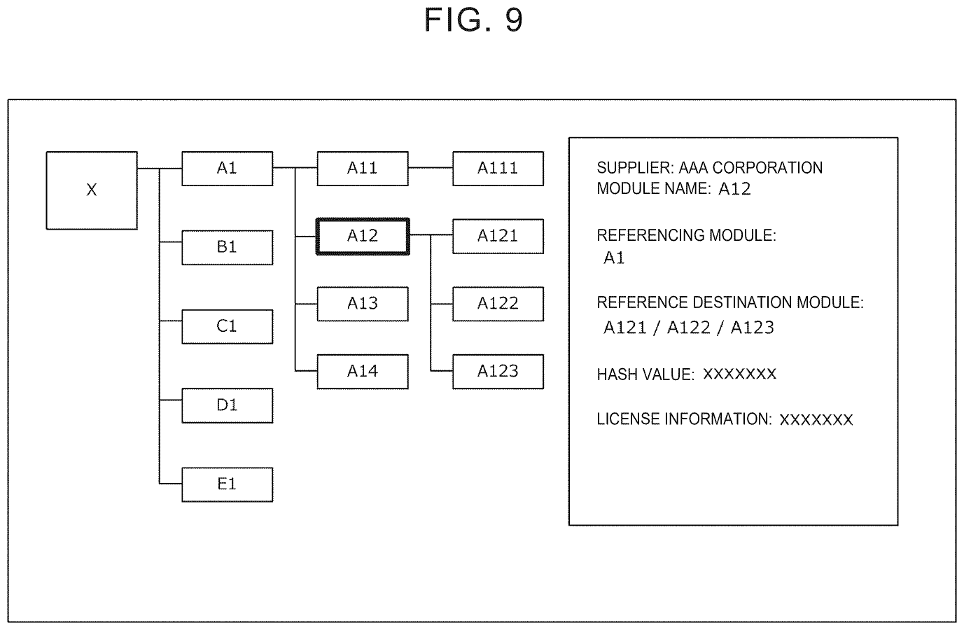

FIG. 9 illustrates an example of a software tree generated by the information acquisition unit 213. The information acquisition unit 213 may execute a process of generating a GUI, such as that indicated as an example, based on the software information received from the server device 1.

In addition, the information acquisition unit 213 may be configured to be able to output information about a specific module based on an operation by an operator of the company terminal 2. For example, when an operator of the company terminal 2 selects a specific module on the GUI, basic information or unique value information on the relevant module may be output.

The storage unit 22 stores the module information generated by the information registration unit 211 and the module package shared by the file sharing unit 212 (i.e., the module package to be delivered to a downstream company).

### Process Flow

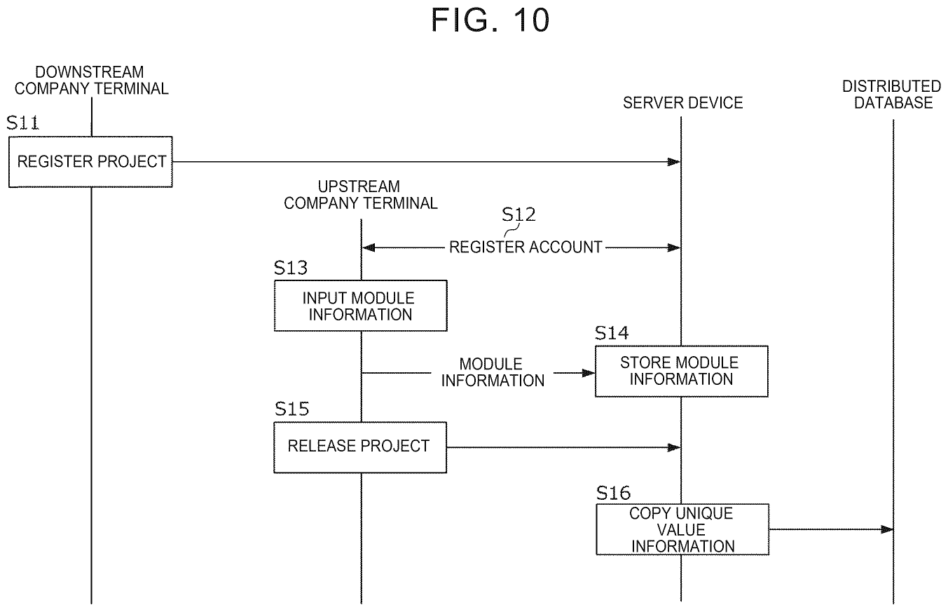

Next, the process executed by the devices constituting the system will be described with reference to FIG. 10. FIG. 10 is a sequence diagram illustrating a process in which the company terminals 2 interact with the server device 1 to register a project.

In one example, the interaction between the server device 1 and the company terminals 2 is started when an operator of each company included in the supply chain logs into the server device 1 via the company terminal 2 using an account of the corresponding company. In the present example, it is assumed that an operator of each company logs into the server device 1 using an account of the relevant company (their own company).

In the present example, in addition, a company terminal corresponding to a downstream company (company A) at a certain tier is defined as a downstream company terminal, and a company terminal corresponding to an upstream company (company B) is defined as an upstream company terminal.

First, in step S11, the downstream company terminal of the downstream company accesses the server device 1 to register a project. The project is a unit for managing module information, and corresponds to a module produced by the company B in the present example.

In step S12, the server device 1 interacts with the upstream company terminal to register account information. This enables the upstream company terminal to log into the server device 1.

In step S13, the upstream company terminal acquires module information about a module produced by the company itself via an operator, and transmits the module information to the server device 1. The module information transmitted to the server device 1 is received by the information collection unit 111, and stored in the storage unit 12 (step S14).

When input of all the module information is completed, the upstream company terminal performs an operation to release the project to the server device 1 (step S15). When this operation is performed, the module information included in the project is determined.

When the project is released, the server device 1 associates the unique value information, of the received module information, with the identifier of the project and the version, and copies the unique value information to the distributed database in association (step S16).

By repeating the above-mentioned process for a plurality of projects, the server device 1 can collect module information about a plurality of modules included in the final software product. In addition, the unique value information included in the module information can be saved in the distributed database that is free from the risk of being tampered with.

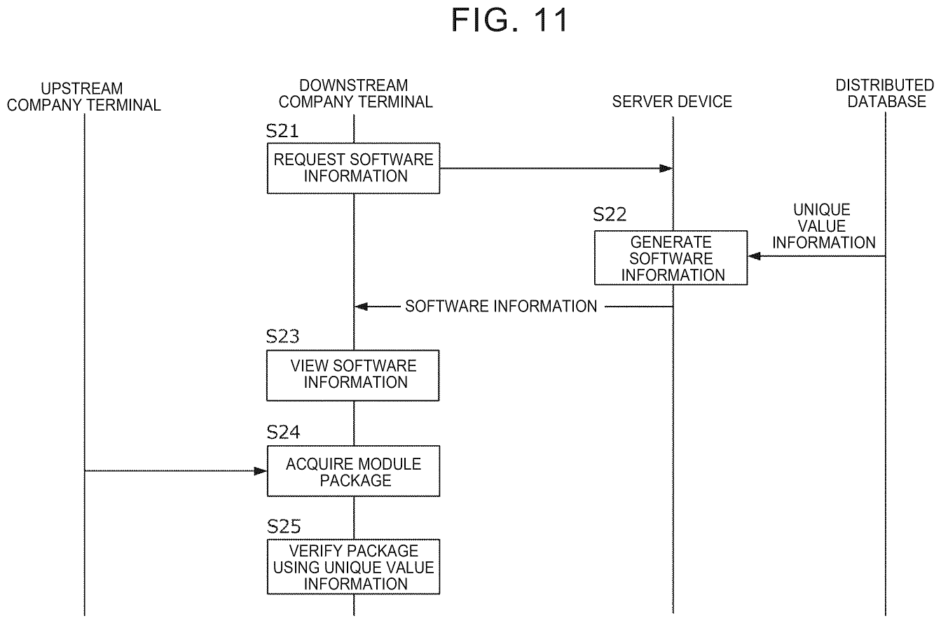

FIG. 11 is a sequence diagram illustrating a process in which software information is provided from the server device 1 to the company terminal 2 and the company terminal 2 verifies a module using the software information. The following describes an example in which the company A (downstream company terminal) as a downstream company acquires software information from the server device 1 and verifies the authenticity of a module package delivered from an upstream company using the software information.

First, in step S21, the downstream company terminal requests the server device 1 to provide software information. This request may be a request for information on all the modules included in the final software product, or may be a request for information on some of the modules.

When the request is received, the server device 1 generates software information in step S22. The software information includes information for generating a software tree such as that illustrated in FIG. 9. In addition, the software information may be associated with basic information and unique value information on each module included in the software tree. Of these pieces of information, the unique value information is acquired from the distributed database.

The generated software information is transmitted to the downstream company terminal to be output. An operator of the company A can view the software tree and information associated with each module (step S23).

In parallel with the above, the company A receives a module produced by the company B from the company B (step S24). In this step, the downstream company terminal acquires a module package from the upstream company terminal using a file sharing function of the upstream company terminal.

In step S25, an operator of the company A references unique value information corresponding to the acquired module package.

For example, when the unique value information is a hash value of the module package, the downstream company terminal computes a hash value of the module package received from the company B, and verifies whether the hash value matches the unique value information viewed in step S23.

As described above, the server device 1 according to the present embodiment collects information about a plurality of software modules constituting a final software product, and provides this information to the company terminal 2. The provided information includes unique value information on each software module, and each company can verify that a module package delivered from an upstream company is authentic using the unique value information. In particular, the unique value information is stored in the distributed database, not in the server device 1, and therefore it is possible to suppress the risk of the unique value information itself being tampered with.

### Modification of First Embodiment

In the first embodiment, when the company terminal 2 requests software information, the server device 1 provides a software tree corresponding to the final software product. However, it is occasionally not appropriate to disclose the entire software tree to a specific company. Thus, when setting an access authority for each company and providing a software tree to the company terminal 2 corresponding to a certain company, the server device 1 may perform a process of hiding a range that the company is not authorized to access.

For example, a company included in the supply chain may wish to conceal module information on the company itself from other companies. To make this possible, an access authority to module information may be granted between companies. For example, each company may transmit a rule such as “only companies with business relationships are permitted to access module information of the company” to the server device 1, and the server device 1 may set an access authority for each company according to the rule.

In this case, when generating software information, the information providing unit 112 may execute a process of concealing information about modules for which no access authority is given, based on the access authority set for each company. The modules about which information should be concealed may be present on the software tree, but no detailed information may be output even if such modules are selected.

### Modifications

The embodiments described above are merely illustrative, and the present disclosure may be modified as appropriate without departing from the spirit and scope of the present disclosure. For example, the processes and units described in the present disclosure can be combined as desired as long as no technical contradiction occurs.

While the server device 1 stores the module information in the database in the description of the embodiment, the module information may be stored by a unit other than the database.

While a hash value is used as a unique value of a module in the description of the embodiment, information other than a hash value may be used as long as the authenticity of the module (or SBOM) can be verified. For example, a timestamp or the like can be used.

While one of companies with business relationships verifies the authenticity of a module delivered from the other using unique value information in the description of the embodiment, authenticity may be verified for an object other than a module delivered from a company. For example, when a module is produced using open source software (OSS), unique value information corresponding to the OSS may be registered and used to verity authenticity. In this case, a company that uses the OSS may register module information on the OSS in the server device 1. Alternatively, a plurality of pieces of OSS included in the final software product may be managed by the server device 1. Unique value information corresponding to the OSS may be registered in the distributed database. When unique value information on the OSS is registered in a reliable device, the server device 1 may acquire unique value information from the relevant device and generate software information.

The processes described as being performed by a single device may be executed in a distributed manner by a plurality of devices. The processes described as being performed by different devices may be executed by a single device. In a computer system, the hardware configuration (server configuration) that implements functions can be changed flexibly.

The present disclosure can also be implemented by supplying a computer with a computer program that implements the functions described in relation to the above embodiment and causing one or more processors of the computer to read and execute the program. Such a computer program may be provided to the computer through a non-transitory computer-readable storage medium that is connectable to a system bus of the computer, or may be provided to the computer via a network. Examples of the non-transitory computer-readable storage medium include any kind of disk such as a magnetic disk (floppy (registered trademark) disk, hard disk drive (HDD), etc.) and an optical disk (Compact Disc ROM (CD-ROM), Digital Versatile Disc (DVD), Blu-ray Disc, etc.), a read only memory (ROM), a random access memory (RAM), an erasable programmable ROM (EPROM), an electrically erasable programmable ROM (EEPROM), a magnetic card, a flash memory, an optical card, and any type of medium that is suitable for storing electronic instructions.

What is claimed is:

1. An information processing device comprising a controller configured to:
receive module information about a software module from a terminal corresponding to a first entity, the software module being produced by the first entity, one or more of the software modules constituting first software, and one or more of the first entities being included in a supply chain of the first software;
store different parts of the module information in a storage device and a distributed record book, the distributed record book using a block chain platform;
generate software information including information about the one or more of the software modules constituting the first software, based on one or more pieces of the module information stored in the storage device and the distributed record book; and
transmit the software information to a terminal corresponding to a second entity.

2. An information processing device comprising a controller configured to:
receive module information about a software module from a terminal corresponding to a first company, the software module being produced by the first company, one or more of the software modules constituting first software, and one or more of the first companies being included in a supply chain of the first software;
store different parts of the module information in a storage device and a distributed ledger, the distributed ledger using a block chain platform;
generate software information including information about the one or more of the software modules constituting the first software, based on one or more pieces of the module information stored in the storage device and the distributed ledger; and
transmit the software information to a terminal corresponding to a second company.

3. The information processing device according to claim 2, wherein:
the module information includes first information that represents a dependence relationship between software modules and second information that represents a unique value corresponding to a target software module; and
the controller stores the first information in the storage device, and stores the second information in the distributed ledger.

4. The information processing device according to claim 3, wherein the unique value corresponding to the target software module is a unique value of a body of the target software module or a unique value of a software bill of materials corresponding to the target software module.

5. The information processing device according to claim 4, wherein the controller generates, as the software information, tree information that indicates a dependence relationship between a plurality of the software modules constituting the first software.

6. The information processing device according to claim 4, wherein the controller generates, as the software information, tree information that represents a dependence relationship between a plurality of the software modules constituting the first software and unique value information that represents the unique value corresponding to each of the software modules.

7. The information processing device according to claim 2, wherein the controller is configured to:
set, for the second company, a reference authority for the one or more of the software modules constituting the first software; and
perform a predetermined process of concealing a software module for which no reference authority is given to the second company, among the one or more of the software modules constituting the first software, when generating the software information.

8. An information processing method executed by one or more first devices respectively corresponding to one or more companies included in a supply chain of first software and a second device that manages information about the first software, comprising:
the first devices executing a process including
transmitting module information about one or more software modules constituting the first software to the second device, and
requesting software information corresponding to the first software from the second device; and
the second device executing a process including
storing different parts of the received module information in a storage device and a distributed ledger, the distributed ledger using a block chain platform, and
acquiring the module information about the one or more software modules constituting the first software from the storage device and the distributed ledger in response to the requesting, and generating the software information corresponding to the first software based on the acquired module information.

9. The information processing method according to claim 8, wherein:
the module information includes first information that represents a dependence relationship between software modules and second information that represents a unique value corresponding to a target software module; and
the second device stores the first information in the storage device, and stores the second information in the distributed ledger.

10. The information processing method according to claim 9, wherein the unique value corresponding to the target software module is a unique value of a body of the target software module or a unique value of a software bill of materials corresponding to the target software module.

11. The information processing method according to claim 10, wherein the second device generates, as the software information, tree information that indicates a dependence relationship between a plurality of the software modules constituting the first software.

12. The information processing method according to claim 10, wherein the second device generates, as the software information, tree information that indicates a dependence relationship between a plurality of the software modules constituting the first software and unique value information that represents the unique value corresponding to each of the software modules.

13. The information processing method according to claim 8, wherein the second device sets a reference authority for the one or more software modules constituting the first software for each of the one or more companies, and performs a predetermined process of concealing a software module for which no reference authority is given to the company that has requested the software information, among the one or more software modules constituting the first software, when generating the software information.
